(19) United States
(12) Patent Application Publication
(10) Pub. No.: US 2008/0030764 A1
(43) Pub. Date: Feb. 7, 2008

(54) SERVER PARALLEL AGGREGATION

(75) Inventors: Robert Zhu, Redmond, WA (US); Venkatraman Balasubramaniyan, Redmond, WA (US); Michael D. Moore, Snohomish, WA (US); Mansoor Mannan, Redmond, WA (US); Jiong Feng, Kenmore, WA (US); Ying N. Chin, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/460,288

(22) Filed: Jul. 27, 2006

(51) Int. Cl. G06F 3/12

(52) U.S. Cl. 358/1.15

(57) ABSTRACT

A parallel aggregation system implemented in a database programming language that utilizes servers that comprise a heterogeneous server farm. The system employs a central job coordinator that coordinates multiple jobs on many disparately sized server machines. The central job coordinator further assigns jobs to the server machines based on the ability of the machine to undertake the work and the complexity and size of the particular job, and monitors the health associated with the machines that comprise the heterogeneous server farm.

### BACKGROUND

Web analytics or visitor analytics systems are utilized to measure the behavior of visitors to websites. Such systems count every click that a user makes when the visits a website, which website the user came from, and should the user leave the website, to which the user went. Further, web analytics systems keep track of the user's activities while the user remains on the site, e.g. which links were clicked, what part of the website did the user dwell in the longest, etc.

On large websites the number of visitors that may be attracted to the site can range in the thousands, if not the hundred thousands, and dwell time within a site can last from a few minutes to an hour or more. As can be appreciated keeping track of all these clicks can generate vast quantities of data. Further, effectively analyzing such information can also pose monumental computational challenges, not least of which is that with such large amounts of data being generated on a daily basis that computational analysis of such information cannot be completed within a single 24 hour period.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The claimed subject matter relates generally to parallel processing, and more particularly, to parallel aggregation utilizing multiple disparate servers to distribute tasks and retrieve from the distributed tasks data for further processing and/or aggregation.

The claimed subject matter in order to achieve its aims employs two components, a job creator component and a job client component. The job creator component acts as a central dispatcher and provides mechanisms to partition an aggregation job into smaller more manageable elements so that these elements can be distributed to a plurality of small servers for processing. The job creator component during the partitioning of the aggregation job into the plurality of elements and sub-elements maintains a job tree. The job tree is employed to preserve any inter-process dependencies that might exist within the aggregation job.

Once the job creator has partitioned the aggregation job, the creator component can identify servers within the server farm to undertake execution of the created elements of the aggregation job and upon identification assign the job element to the identified server. During execution of the job element by the identified server the creator component monitors the job by periodically requesting status information regarding the job and the server that is executing the job. Once the job element has concluded execution, notification is provided to the creator component whereupon the creator agent can determine whether the results generated comport with the strictures of the overall aggregation job.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a system that effectuates parallel aggregation.

FIG. 2 depicts an exemplary federated server farm.

FIG. 3 is detailed depiction of an exemplary job creator component.

FIG. 4 is a detailed illustration of an exemplary job client component.

FIG. 5 is a flowchart diagram of a method that effectuates the exemplary job creator.

FIG. 6 is an illustration of an exemplary job tree that can be employed by the claimed subject matter.

FIG. 7 is a further depiction of the exemplary job tree.

FIG. 8 is an illustration of an exemplary user interface that can be employed by the claimed subject matter.

FIG. 9 illustrates an exemplary server table employed by the claimed subject matter.

FIG. 10 is a schematic block diagram illustrating a suitable operating environment for aspects of the subject innovation.

FIG. 11 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

As a preliminary matter, for ease of exposition the claimed subject matter is described herein in terms of a web analytics/visitor analytics system that measures the behavior of visitors to a website. However, it will be appreciated by those skilled in the art that the claimed subject matter is not so limited and thus can find application in other areas where de-serialization of processing is of manifest interest to reduce overall processing time necessary to complete extremely large processing jobs.

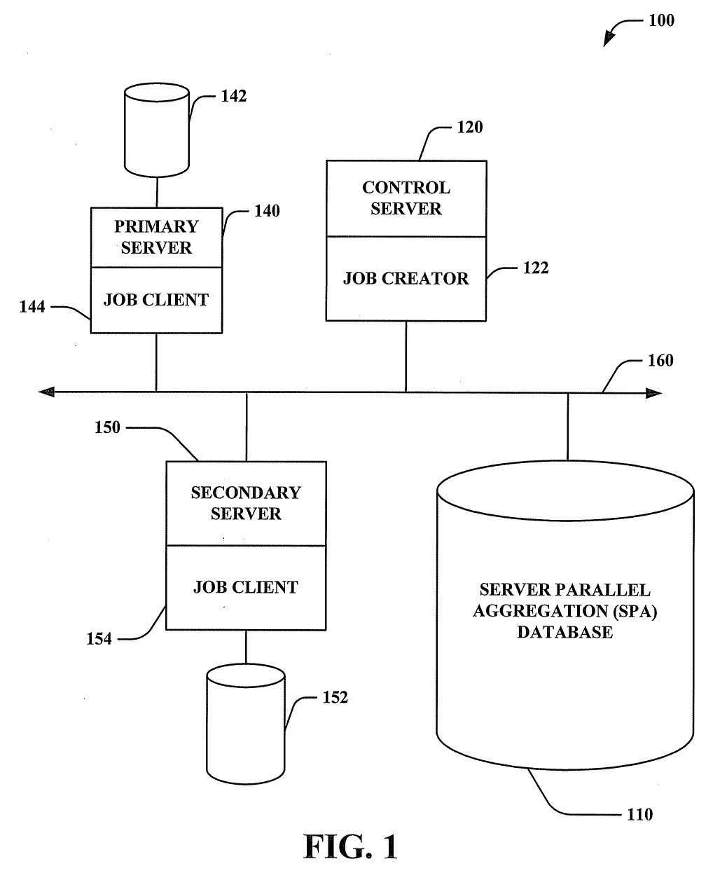

FIG. 1 illustrates a system 100 that effectuates parallel aggregation to take advantage of multiple disparate servers to distribute jobs and to retrieve data from the distributed jobs for further processing and/or aggregation. System 100 can comprise a Server Parallel Aggregation (SPA) database 110 that stores the totality of logs/data associated with a web analytics/visitor analytics system, a control server 120 that can include a job creator component 122, a primary server 140 and associated database 142 that can include a job client component 144, and secondary server 150 and associated database 152 that can include a job client component 154. The Server Parallel Aggregation (SPA) database 110, control server 120, primary server 140 and secondary server 150 are networked together via a communications medium 160 (e.g., Ethernet, Wi-Fi, Fibrechannel, Fast Ethernet, Gigabit Ethernet, etc.).

The Server Parallel Aggregation (SPA) database 110 in addition to storing the entirety of logs/data associated with the web analytics/visitor analytics system can further store tables (e.g., server tables, job tables, . . . ) associated with, and utilized by, the claimed subject matter. Alternatively and/or additionally, the tables (e.g., server table, job tables, and the like) associated with the claimed subject matter can be resident in the memory (e.g. ROM, RAM, etc.) of the control server 120 or in local storage units associated with the control server 120.

The Server Parallel Aggregation (SPA) database 110 in concert with the job creator component 122 included with the control server 120 can optimally partition an aggregation job into smaller more manageable partitions, and based on these smaller partitions the job creator component 122 can distribute these manageable partitions to primary server 140 and secondary server 150 depending on each of the primary server 140 and secondary server 150 needs and/or abilities. The job creator component 122 in optimally partitioning the aggregation job can ensure that any dependencies that can be inherent in effectuating the aggregation in its entirety are preserved, thereby ensuring that any corruption to the overall aggregation that may be caused by the optimal partitioning of the aggregation job are mitigated and/or eliminated.

The job creator component 122, in addition to optimally partitioning the aggregation job, can determine which of the primary server 140 and/or secondary server 150 are able to handle particular partitioned jobs. For example, the primary server 140 can be one that has abundant resources and a fast processing speed, whereas the secondary server 150 can be one that has a paucity of resources and a diminished processing speed in comparison to the primary server 140. Thus, the job creator component 122 can recognize that primary server 140 is a better candidate for jobs that require more complex computations than the secondary server 150, and that the secondary server 150 is a more suitable option for basic qualification jobs.

Further, the job creator component 122 can ascertain whether a particular server, primary server 140 or secondary server 150, has ceased to be functional. Where the job creator component 122 determines that a particular server has ceased to be operationally functional, the job creator component 122 can allocate, transfer and/or redistribute a partitioned job to another server that is capable of completing the job. It should be noted that when allocating, transferring and/or redistributing partitioned jobs that have been partially completed by a failed server, that the computations that have already been effectuated up until failure do not have to be redone. In other words, where a partitioned job is partially complete only the incomplete remainder of the partitioned job need be transferred or redistributed to a server capable of completing the partitioned job. Thus, the job creator component 122 can determine whether a partitioned job has failed to complete, the causes of the failure (e.g. hardware malfunction, communications breakdown, etc.), whether the partitioned job can be reassigned, identify a server that is capable of undertaking the reassigned job to completion, and transferring the incomplete portion of the reassigned job to the identified server, for example.

It should be appreciated that while the job creator component 122 is depicted as being included with control server 120 and thus distinct unto itself, it will be appreciated by those conversant with the art that the job creator component 122, or aspects thereof, can in the alternative be included with the primary server 140 and/or the secondary server 150 without departing from the purview of the claimed subject matter.

Primary server 140 as described herein is typically a machine that has the greatest resources (e.g., multiple CPUs, processing speed, memory, paging and swap space, disk space, etc.). The primary server 140 is capable of undertaking and manipulating very large portions of the aggregation job on its own. Moreover, in addition to handling the many disparate partitioned jobs assigned it by the job creator component 122, the primary server 140 is further utilized to receive results generated by the secondary server 150 once the secondary server 150 has completed processing on the partitioned jobs assigned it.

The secondary server 150 in contrast is a machine that in comparison to the primary server 140 has lesser resources, and thus is typically assigned jobs of smaller size and reduced complexity. Nevertheless, it will be appreciated that the primary server 140 and the secondary server 150 can be of equal capabilities without departing from the scope and intent of the claimed subject matter.

With respect to job client components 144 and 154 that are included in primary server 140 and secondary server 150 respectively, a distinction is made for the purposes of elucidation and to provide those skilled in the art with a better understanding of the claimed subject matter. Job client components 144 and 154 while both operating in a substantially similar manner nonetheless can differ in the fact that the job client component 144 situated on the primary server 140 can also be responsible for additional responsibilities concomitant with the greater computing resources associated with the primary server 140.

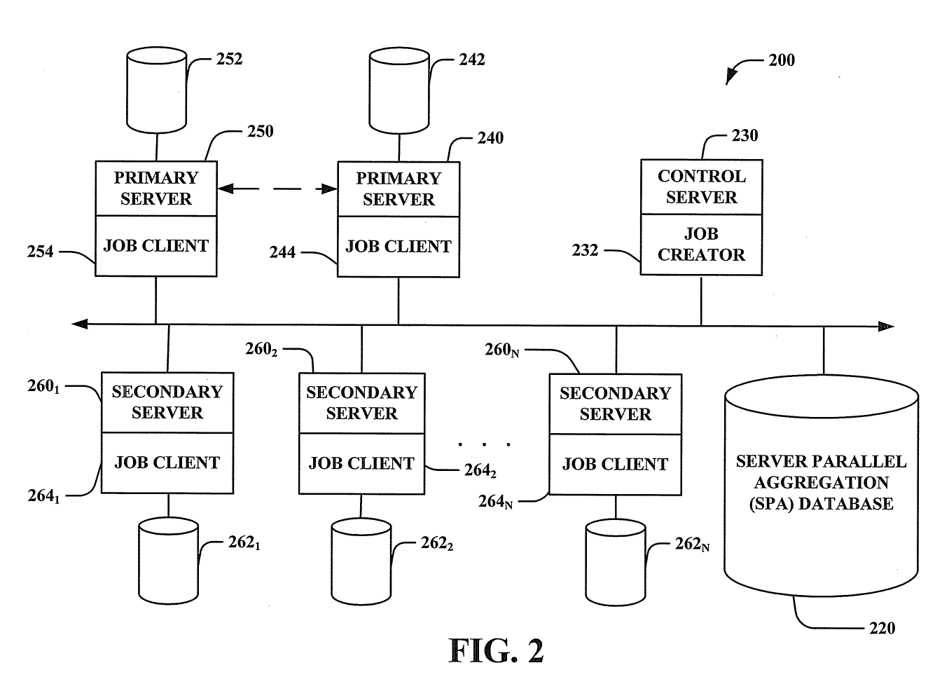

FIG. 2 is an illustration of a federated server farm 200 that includes a Server Parallel Aggregation (SPA) database 220, a control server 230 and associated job creator component 232, primary servers 240 and 250 together with associated disk storage units 242 and 252 and respective job client components 244 and 254, and secondary servers 260₁, 260₂ . . . 260_{N} and their associated disk storage units 262₁, 262₂ . . . 262_{N}, and respective job client components 264₁, 264₂ . . . 264_{N}. As depicted by the broken or dashed line that connects the two primary servers 240 and 250, the primary servers 240 and 250 provide backup and redundancy for one another. Thus, should primary server 240 become incapacitated for some reason, primary server 250 can step in to undertake the functions associated with primary server 240. Similarly, should primary server 250 cease to be operationally functional, primary server 240 can undertake the functionality associated with primary server 250.

Generally, primary servers 240 and 250 will be machines that are identically configured having the same or similar processing capacity, disk space, memory and the like. However, primary servers 240 and 250 can within reasonable bounds be configured in slightly disparate manners (e.g., one primary server can have a greater or lesser number of processors, greater or lesser disk capacity, faster or slower processor speeds, greater or lesser memory, and the like) without departing from the scope and intent of the subject claimed matter.

With respect to secondary servers 260₁, 260₂ . . . 260_{N}, these too can be identically configured though typically secondary servers 260₁, 260₂ . . . 260_{N} will comprise machines of disparate capabilities wherein each secondary server 260₁, 260₂ . . . 260_{N} will have its own unique attributes and characteristics. Thus, for example, secondary server 260₁ can be a machine with the slowest processor in the federated server farm, but it may be the machine with the largest disk capacity and memory. As a further example, secondary server 260₂ can be configured with an array of processors, with minimal disk capacity and a moderate amount of memory. Given the disparity and variety of machines and physical attributes of the machines that can comprise the server farm 200 it can be referred to as being asymmetrical. Nevertheless, the claimed subject matter can also find application where all the machines that comprise the server farm 200 have identical attributes and equal capabilities.

At the outset, the job creator component 232 in concert with the Server Parallel Aggregation (SPA) database 220 effects distribution of source data to all the machines that comprise the federated server farm 200. In this instance, primary servers 240 and 250, and secondary servers 260₁, 260₂ . . . 260_{N} are provisioned with their own copies of the source data that can be stored in data stores 242, 252, and 262₁, 262₂ . . . 262_{N}, associated with each of the primary and secondary servers. The provisioning of the primary servers 240 and 250 and secondary servers 260₁, 260₂ . . . 260_{N} can be accomplished, for example, via Data Transformation Services (DTS), from the Server Parallel Aggregation (SPA) database 220. Nonetheless, it should be appreciated that while DTS has been selected herein to effectuate data transfer between the database and servers, and between the servers themselves, that alternative data transfer methodologies (e.g., bulk copy, bcp, data replication, etc.) can also be employed and as such fall within the intended ambit of the claimed subject matter.

Once the source data has been distributed from the SPA database to the entirety of the servers that comprise the federated server farm 200, the job creator component 232 can commence partitioning or sub-dividing an aggregation job into more manageable sub-processes while contemporaneously ensuring that any dependencies that may be inherent in the aggregation job are preserved. The job creator component 232 can effectively sub-divide the entire aggregation job in one pass noting, where appropriate, any inter-process dependencies that might exist between sub-processes, or the job creator component 232 can sub-divide the aggregation job on demand at which point the job creator component 232 can determine whether inter-process dependencies exist in real-time.

The job creator component 232 having partitioned the aggregation job into at least one sub-process and noted any dependencies that the may be extant between the partitioned sub-process and other sub-processes, can determine and identify servers within the federated server farm 200 that are capable of undertaking the particular partitioned sub-process. In order to ascertain and identify appropriate servers on to which the transfer the partitioned sub-process, the job creator component 232 can consult one or more tables (e.g. a server table) that can be stored within the SPA database itself, or may be located in local memory of the control server 230 to which the job creator component 232 is associated. The one or more tables can indicate comparative characteristics of all the servers that exist in the server farm 200, such characteristics can include the number of processors that a particular server has, the speed of the processors, the memory available, the disk space available, etc. Further, the one or more table can include information regarding whether the server has been classified as a primary or secondary server.

The job creator component 232 when identifying suitable nodes to which to distribute partitioned portions of the aggregate job must ensure that the server to which work is distributed has sufficient resources/capacity with which to undertake the assigned work. The reason for this consideration being that while the job creator 232 attempts to partition the aggregation job into smaller more manageable sections it is to be recognized that certain portions of the aggregation job may be irreducible and of such complexity that it can only be executed on but a few servers in the server farm 200. Where this is the case, the job creator component 232 can selectively assign servers with the most capacity and resources to undertake such irreducible sub-processes. Typically, these irreducible sub-processes will be assigned to primary servers 240 and 250 rather than secondary servers 260₁, 260₂ . . . 260_{N}, but nevertheless, if there exist secondary servers capable of undertaking such irreducible sub-partitions, the job creator component can assign such sub-processes to secondary servers 260₁, 260₂ . . . 260_{N} accordingly.

When a server in the server farm 200 has been assigned a particular sub-process the job creator component 232 can update one or more job tables that can be resident in local memory and/or in the SPA database. The one or more job tables can include fields relating to the identity of the partition assigned, the identity of the server to which the partition is allocated, the status of the server, the status of the job, and the time within which the allocated server is to report back the job creator component 232.

The job creator component 232 can further periodically ping servers 240, 250 and 260₁, 260₂ . . . 260_{N} to which partition jobs have been assigned to ascertain the viability of both the server and the sub-jobs executing thereon. For example, the job creator component 232 can ping respective servers every hour, though shorter or longer time periods can be selected. The job creator component 232 then waits for an appropriate response from the pinged server. Where an appropriate response is elicited from the pinged server the job creator component 232 can update appropriate fields in tables residing either in local memory of the control server 230 and/or in tables contained within the SPA database 220. Where no response is received from the pinged server the job creator component 232 can make a determination that the non responding server is some how incapacitated and accordingly update tables existing in local memory of the control server 230 and/or in tables existent within the SPA database 220 to reflect this fact. Further, where the job creator component 232 determines that a server has become incapacitated and/or is unable to complete an assigned task to completion, the job creator component 232 can determine how much of the assigned task remains to be completed and then reassign the remainder to another server capable of completing the task. It should be noted that when an incomplete task is reassigned to another server for completion, the server assigned the reassigned task does not restart processing of the sub-process from the beginning, but rather from wherever the failed server ceased processing.

Additionally, since the job creator component 232 in effect acts as a central dispatcher, the job creator component 232 once it has dispatched a partitioned job to a server can receive notification from the server, e.g., primary servers 240 and 250 and secondary servers 260₁, 260₂ . . . 260_{N}, to the effect that the tasked server has completed its task. Upon receipt of notification of completion, the job creator component 232 can verify that the results generated by the server are pertinent and consistent with the overall aggregation job, at which point the job creator component 232 can update appropriate tables and resolve any dependencies that completion of the task might have impinged.

Job client components 244, 254, and 264₁, 264₂ . . . 264_{N}, that are associated with primary servers 240 and 250 and secondary servers 260₁, 260₂ . . . 260_{N}, once notified by the job creator component 232 that an associated server has been assigned a task can automatically procure the job assignment from the control server 220 and launch a process to execute the assigned task on the associated server. For example, if primary server 240 is assigned a task by the job creator component 232, the job client component 244 can obtain the job assignment from the control server 220 and subsequently start processing the assigned task. During task execution the job client components 244, 254, and 264₁, 264₂ . . . 264_{N} perpetually monitor the progress of the assigned task on their respective servers, ascertain the physical health of their server, and respond to ping requests emanating from the job creator component 232.

The respective job client components 244, 254, and 264₁, 264₂ . . . 264_{N} in responding to the ping from the job creator component 232 can reply by sending for example, information regarding the status of the task assigned (e.g., how much of the job has been completed) and information regarding the health of the server (e.g., how much disk space and memory has been utilized, if a multi-processor server indication of the status of each and every processor, and the like). Alternatively and/or additionally, the respective job client components 244, 254, and 264₁, 264₂ . . . 264_{N} can undertake to communicate with the job creator component 232 of its own volition at predetermined and/or random time intervals in order to apprise the job creator component 232 of the health status of the associated server.

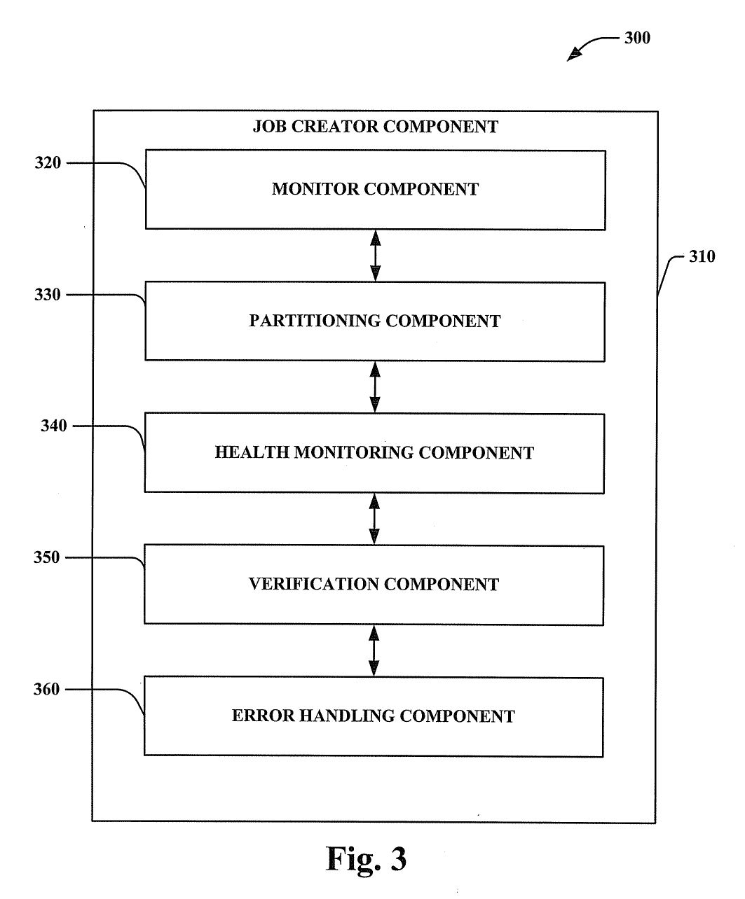

FIG. 3 is a more detailed depiction of the job creator component 310 that can include a monitor component 320 that monitors and displays the activity and disposition of the aggregation job in its totality as well as all the partitioned and sub-partitioned jobs that have been distributed to primary and secondary servers. Further the job creator component 310 can also include a partitioning component 330 that partitions an aggregation job into the multiple partitioned and sub-partitioned jobs, and a health monitoring component 330 that obtains information from the plurality of servers over which the job creator component 310 has dominion, and based on this information provides recommendations as to how to resolve problems associated with the failure of the servers. Additionally, the job creator component 310 can further include a verification component 350 that upon receipt of indication that partitioned and sub-partitioned jobs have been completed can determine whether the results generated by the various servers to which the job creator component 310 has assigned tasks are pertinent to the overall aggregation job, and a error handling component 360 that upon receipt of indication that a particular server or a partition or sub-partition executing thereon has failed can ascertain alternative servers to which to assign the failed job.

As noted supra, the job creator component 310 has overall control of all the processes that comprise the claimed subject matter. The job creator component 310 can receive an aggregation job and thereupon divide the received aggregation job into smaller logical partitions or sub-jobs for subsequent processing and distribution to multiple disparate servers that can comprise a federated server farm. In order to ensure that the received aggregation job completes to successful fruition the job creator component 310 in dividing or partitioning the received aggregation job must be cognizant that the aggregation job can include many sub-processes that can have multiple inter-process dependencies. For example, in the context of web analytics/visitor analytics, monthly statistics cannot be computed prior to completion of daily statistics, and in the same vein, yearly statistics cannot be computed before all the monthly statistics have been computed. As can be observed the sequence and ordering of operations have to be taken into account and maintained for many of the computations. Thus, in order to maintain these multiple inter-process dependencies the job creator component 310 can maintain a job tree that maintains the dependencies and ordering that is necessary for the aggregation job to complete successfully.

Additionally, the job creation component 310 must be aware that communications between different physical machines exact different latencies than processors situated on the same server. For example, the job creation component 310 should be aware that communications between processors situated on the same multi-processor machine will be much faster than communications between servers that are remote from one another.

Moreover, the job creator component 310 in distributing partitioned or sub-partitioned jobs must be cognizant that the server farm comprises machines and processors with disparate capabilities. For example, machines included in an exemplary server farm can be divided into two classifications, primary servers and secondary servers. Primary servers typically can be the most powerful servers with regard to processing speeds and other resources, whereas secondary servers can generally be machines that are not so powerful in comparison. For instance, a computing platform with 64 processors and abundant memory resources can typically be deemed a primary server, whereas a dual processor machine with minimal memory capacity can generally classified as being a secondary server. Thus, the job creator component 310 recognizing the distinctions between disparate machines that comprise its federated server farm can allocate very large and complex sub-partitions of the aggregation job to primary servers and conversely can allocate smaller, less complex sub-partitions to secondary servers.

Furthermore, the job creator component 310 must also be able to discern that while certain aspects of the aggregation job can elicit a great deal of dependency there can be other aspects of the aggregation job that can be processed concurrently.

The monitor component 320 simply put provides real-time monitoring of all servers and processes executing thereon. The monitor component 320 provides a visual display (e.g., via a Graphical User Interface (GUI)) of the processes and events occurring within a particular server farm. The monitor component 320 further provides visual indication of the progress of the aggregation job in its entirety, as well as the progress of jobs that have been partitioned or sub-partitioned by the job creator component for processing on one or more disparate servers in the server farm. The monitor component 320 ascertains from the plurality of servers information such as, for example, the number of jobs that a particular server has remaining in its queue, the amount of disk space that is currently being utilized, the current CPU usage, how much of partitioned job has been completed, and the like.

The partitioning component 330 where possible divides a received aggregation job into smaller more manageable sub-tasks so that these sub-tasks can be distributed to appropriate servers in a heterogeneous server farm. The partitioning component 330 while sub-dividing the received aggregation job contemporaneously constructs a dependency job tree that ensures that any and all inter-process dependencies that may be inherent in the aggregation job are maintained and preserved throughout the processing of the aggregation job despite the aggregation job being sub-divided into sub-tasks for processing on a multitude of servers. The partitioning component can also determine and identify suitable servers within the federated server farm that are capable of undertaking the particular partitioned tasks through use of one or more database server tables.

The health monitoring component 340 can periodically ping servers to which partitioned sub-tasks have been assigned to ensure that the servers are still diligently processing the jobs and to determine whether resources associated with the servers are being utilized in an appropriate manner. To facilitate this functionality the health monitoring component 340 at certain predefined intervals sends to the servers a request for information at which point the health monitoring component 340 waits for a predetermined time for an appropriate response from the pinged servers. Should a server not respond within the pre-allocated time, the health monitoring component 340 can deduce that the viability of the pinged server has become compromised in some manner, and as such can inform the job creator component 310 that corrective action may be required to rectify the situation with respect to the non-responding server and any tasks that may have been assigned it by the partitioning component 330.

Once a partitioned task has completed processing, the verification component 350 can peruse the results generated and determine whether the particular task completed without errors and whether the results are pertinent to the overall aggregation job. Results can, for example, occasionally become superfluous or redundant where the job creator component 310, albeit in error and based on information from the monitoring component 320 and the health monitoring component 340, determines that a particular server has currently become moribund and as such the partitions or sub-tasks assigned it have little or no chance of completing to a desired conclusion. Thus, where such a situation arises the verification component 350 can, for example, utilize one or more the tables resident on the SPA database to ascertain that the partitions or sub-tasks at issue have been successfully completed by another server, and that as a consequence that the received results should be discarded.

The error handling component 360 of the job creator component 310 is utilized to determine a course of action that should be adopted when available information indicates that either a server processing a assigned task has failed or where a time limit associated with the expected completion of the task has expired. The error handling component 360 can utilize information gathered by any of the aforementioned components to make its determination. The error handling component 360 can, based on the information available and possibly a cost-benefit analysis, determine that in certain situations that it may be more beneficial to retry a failed sub-process on a particular server rather than re-assigning the failed sub-process to another server that is capable of completing the failed sub-process, but nevertheless is significantly slower than the original server upon which the sub-task was initially processing. Alternatively, the error handling component 360 can determine based on the point of failure of the sub-process, that rather than assigning the task to a server of equal magnitude to the original server that failed to complete the task, that a more beneficial line of attack would be to further sub-partition the incomplete portion of the original sub-task and distribute these to other albeit smaller less powerful servers.

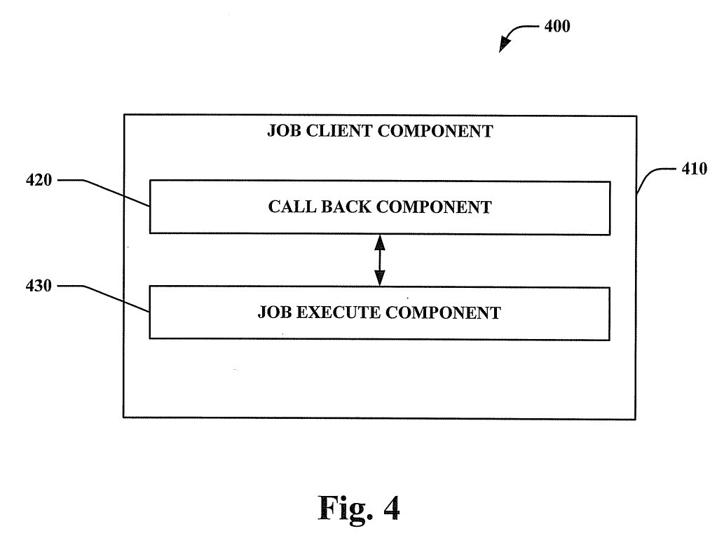

FIG. 4 is a more detailed illustration of the job client component 410 that includes a call back component 420 that dispatches status information in response to a status request (ping) from a job creator component, and a job execute component 430. The call back component 420 responds to status requests that can be received from a job creator component associated with a control server, and as such, call back component 420 can be thought of as the counterpart of the health monitoring component situated within the job creator component described above. The call back component 420, in response to a status request from the job creator component, returns within a prescribed time period a report containing information regarding the status of the tasks assigned to the server associated with the job client component 410 (e.g., the proportion of assigned tasks that are nearing completion), and information regarding the health of the server (e.g., memory utilization, disk space indications, and the like).

The job execute component 430 determines whether a task or group of tasks has been assigned to the server by a job creator component. When the job execute component 430 determines that tasks have been assigned to the server, the job execute component 430 automatically procures the assigned task(s) from the control server and subsequently launches a process to execute the prescribed task(s) on the server.

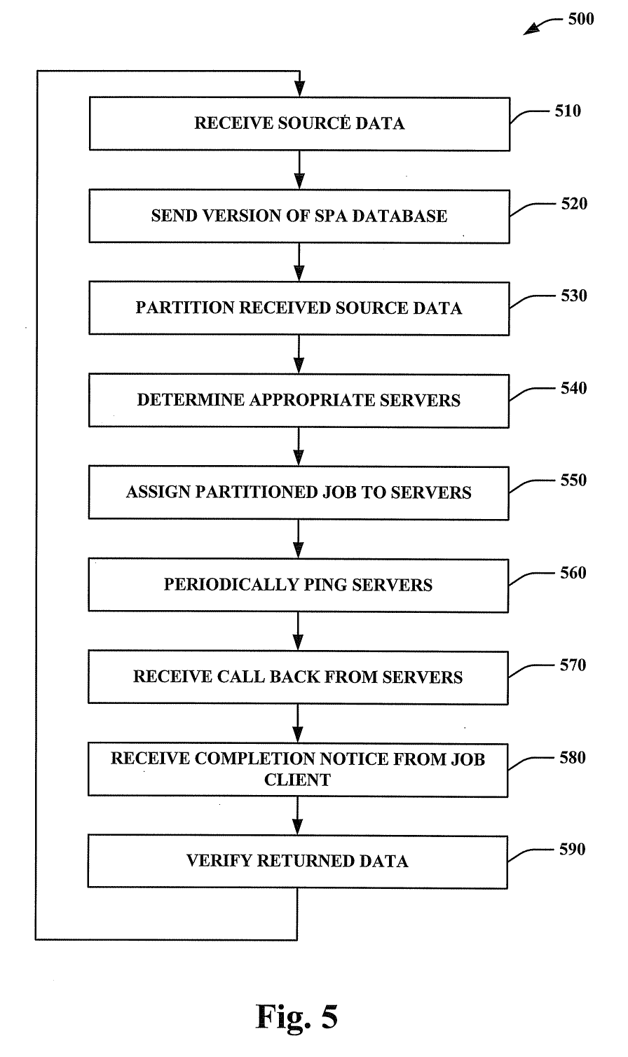

In view of the exemplary systems described supra, methodologies that may be implemented in accordance with the disclosed subject matter will be better appreciated with reference to the flow chart of FIG. 5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

FIG. 5 illustrates a method that effectuates the exemplary job creator component described herein. The method commences at 510 where a job creator component receives an aggregation job. At 520 the job creator job in concert with a SPA database distributes a portion of the database relevant to the aggregation to various servers that comprise a heterogeneous federated server farm that can comprise machines of many disparate varieties and types. The portion of the SPA database is transferred to the various severs via DTS data transfer. At 530 the job creator component partitions the received source data into multiple smaller partitions appropriate to distribute to the servers that comprise the server farm and constructs a job tree to ensure that inter-process dependencies that may exist are preserved and maintained to ensure that the aggregation job completes successfully. At 540 the job creator component determines which of servers in the server farm would be appropriate to undertake the partitioned jobs. At 550 the job creator agent, based on the determination made at 540, assigns the partitioned job(s) to the appropriate server whereupon the server commences processing of the partitioned job(s). At 560 the job creator component periodically pings the server, and more particularly the job client running on the server, to ascertain and gather progress information regarding the assigned job(s) as well as to ascertain health information regarding the server itself. At 570 the job creator component waits for a prescribed amount of time for a call back from the job client component associated with the server. Where no call back is received by the job creator component within the prescribed time period the job creator component can initiate corrective action such as curtailing execution of the task on the server. At 580 the job creator component can receive a completion notice from the job client associated with a server to which a partitioned job was assigned. At this point the job creator component can determine whether there are any more jobs that can be distributed to the server for execution. At 590 the job creator agent verifies whether the returned results are those that it expects. If the results are not what is expected the job creator component can transfer the job to another server for processing, or if the results for the particular sub-task have now become obsolete the results can be discarded.

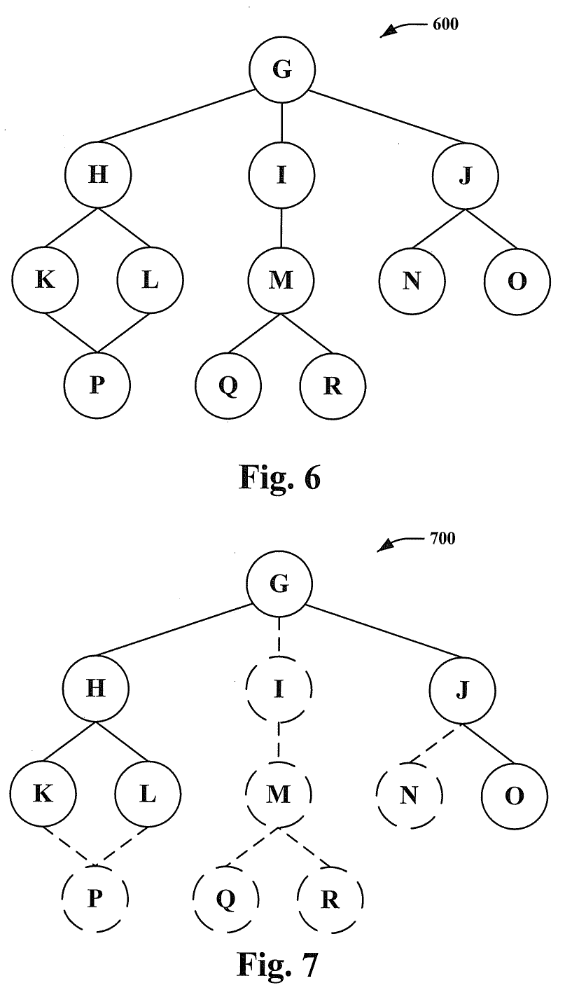

FIG. 6 illustrates an exemplary job tree 600 that can be employed by the claimed subject matter in order to coordinate and synchronize the multitude of partitioned jobs that are distributed to multiple servers by the job creator component. Since the aggregation job in its totality may have many components that can have multiple dependencies on other components the job creator component must have some facility to keep track of all these dependencies in order to ensure the integrity of the aggregation job as a whole. As illustrated in FIG. 6 the job creator component has determined that a portion of the overall aggregation job can be sub-partitioned into 12 sub-partitions G-R. Further, the job creator component has further ascertained that sub-partitioned job G cannot complete its processing without information from jobs H-J, and thus is dependent on the results from jobs H-J. Job H as illustrated is in turn dependent on the results from jobs K, L and P wherein both jobs K and L are both dependent on the results supplied by job P, job I is dependent on the results from jobs M, Q and R, and similarly, job J is dependent on the results from jobs N and O.

FIG. 7 is a further depiction of an exemplary job tree 700 described in relation to FIG. 6, wherein jobs I, M, N, P, Q and R have completed processing and have supplied results to those jobs that were dependent upon them for continued processing. Nevertheless, as illustrated job G still cannot complete processing as it is awaiting results from jobs H and J, which in turn are waiting for results and the completion of jobs K, L and O.

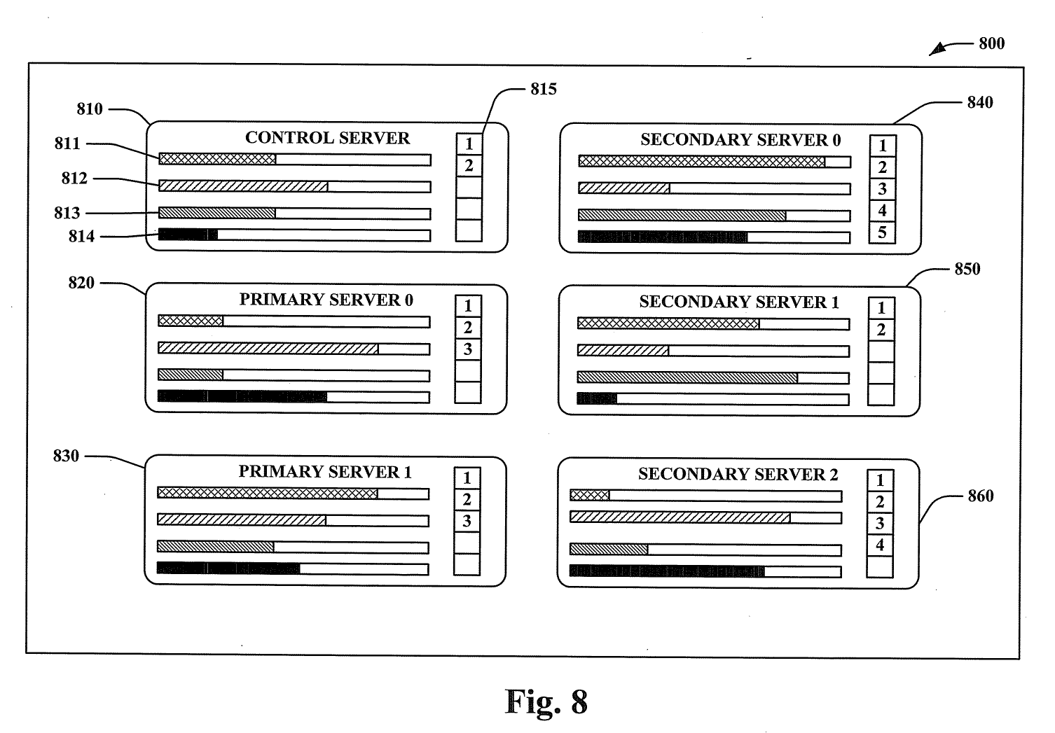

FIG. 8 illustrates an exemplary user interface 800 that provides users the ability to view the progress of the aggregation job in its entirety as well as the progress of jobs that have been partitioned or sub-partitioned by a job creator component. The user interface 800 can include multiple modules that can correspond, for example, with the number of physical processors that are processing jobs partitioned by the job creator component. As illustrated, the user interface 800 includes a control server module 810 that represents activity occurring on a control server, a primary server 0 module 820 and primary server module 830 representative of activity occurring on primary server 0 and primary server 1 respectively, and secondary server 0 module 840, secondary server 1 module 850 and secondary server 2 module 860 representative of activity occurring on secondary servers 0-2 respectively. Each module as displayed in the user interface 800 for the purposes of each of explanation displays identical attributes relating the health of the particular server and information about the progress of the aggregation job as a whole, or in the case of primary server 0, primary server 1, and secondary servers 0-2 progress of partitioned jobs that have been assigned to the respective servers by the job creator component.

With respect to control server module 810, this module can include for example, an attribute 811 that shows the percentage of CPU that is currently being utilized by the aggregation job, attribute 812 that displays the amount of memory that is being used by the aggregation job, attribute 813 displays the amount of disk space that is currently being utilized by the aggregation job, attribute 814 that shows how much of the aggregation job is complete, and attribute 815 provides information regarding the partitioned jobs that exist in a job queue awaiting processing.

Similarly, with respect to modules related to primary server 0 (820) primary server 1 (830), and secondary servers 0-2 (840-860), very much the same exemplary information as described above in relation to the control server module 810 can be displayed. However, in contrast to displaying how much of the overall aggregation job is complete and the contents of the job queue, the respective attributes can display how much of an individual job assigned to a particular server is complete, and which jobs exist locally in the respective job queues.

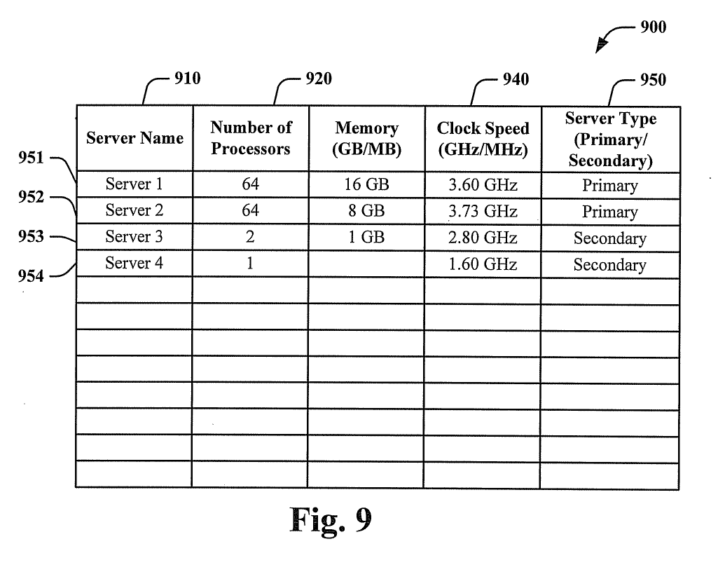

FIG. 9 illustrates an exemplary server table 900 that can be employed by the claimed subject matter. The server table 900 can comprise, for example. a server name field 910 that uniquely identifies the server in the network (e.g., via IP address, MAC address, unique name, etc.), a processors field 920 that provides indication as to the number of processors that the identified server has available for processing, a memory field 930 that provides information as to the amount of memory that an identified server has available, a clock speed field 940 that provides information regarding the clock speed of the processor(s), and a server type field 950 that identifies whether the identified server is classified as a primary or a secondary server. As illustrated at 951 and 952 servers 1 and 2 respectively have been identified as being primary servers based on the fact that each of these servers has 64 processors, and at 953 and 954 servers 3 and 4 have been identified as being secondary servers given the paucity of resources in comparison to the identified primary servers.

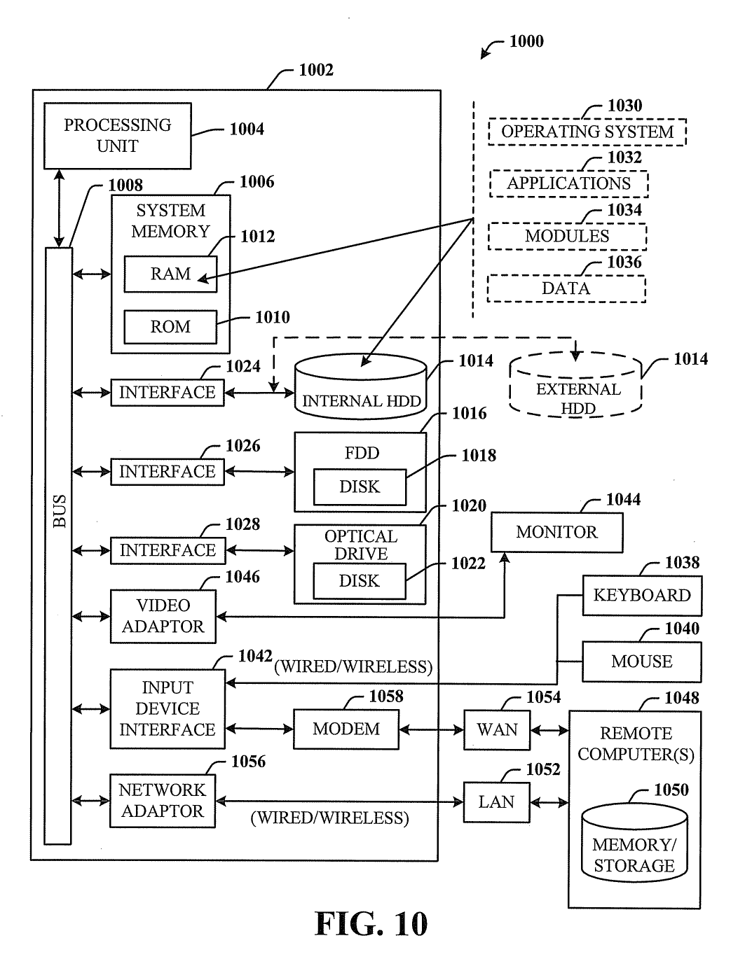

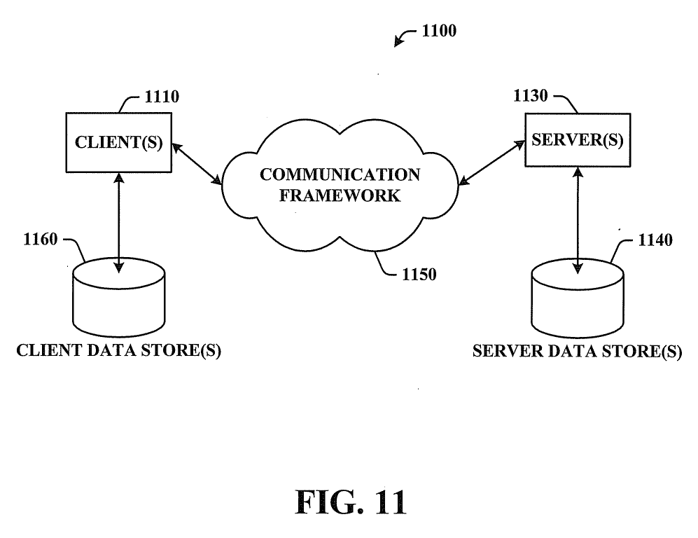

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

As used in this application, the terms “component,” “system” and the like are intended to refer to a computer-related entity, either hardware, a combination of hardware and software, software or software in execution. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Artificial intelligence based systems (e.g. explicitly and/or implicitly trained classifiers) can be employed in connection with performing inference and/or probabilistic determinations and/or statistical-based determinations as in accordance with one or more aspects of the subject innovation as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a system, method, apparatus, or article of manufacture using standard programming and/or engineering techniques to produce software, firmware, hardware or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

With reference to FIG. 10, an exemplary environment 1010 for implementing various aspects disclosed herein includes a computer 1012 (e.g., desktop, laptop, server, hand held, programmable consumer or industrial electronics . . . ). The computer 1012 includes a processing unit 1014, a system memory 1016, and a system bus 1018. The system bus 1018 couples system components including, but not limited to, the system memory 1016 to the processing unit 1014. The processing unit 1014 can be any of various available microprocessors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like displays (e.g., flat panel and CRT), speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1016, it can also be external to computer 1012. The hardware/software necessary for connection to the network interface 1048 includes, for exemplary purposes only, internal and external technologies such as, modems including regular telephone grade modems, cable modems, power modems and DSL modems, ISDN adapters, and Ethernet cards or components.

FIG. 11 is a schematic block diagram of a sample-computing environment 1100 with which the subject innovation can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the subject innovation, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130. By way of example and not limitation, the systems as described supra and variations thereon can be provided as a web service with respect to at least one server 1130. This web service server can also be communicatively coupled with a plurality of other servers 1130, as well as associated data stores 1140, such that it can function as a proxy for the client 1110.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system that effectuates parallel aggregation, comprising:
a job creator component that receives a task that includes a plurality of disparately sized sub-tasks;
a job client component that accepts at least one of the plurality of disparately sized sub-tasks for processing; and
a database component that stores at least one table.

2. The system of claim 1, the job creator component partitions the task into the plurality of disparately sized sub-tasks.

3. The system of claim 2, the job creator component utilizes a job tree to ensure that one or more dependencies associated with the plurality of disparately sized sub-tanks is maintained.

4. The system of claim 2, the job creator component analyzes the plurality of disparately sized sub-tasks and ascertains from a server farm an appropriate server to assign one of the plurality of disparately sized sub-tasks.

5. The system of claim 4, the server farm includes primary servers and secondary servers.

6. The system of claim 5, the primary servers include a first primary server and a second primary server, the first primary server and the second primary server identically configured.

7. The system of claim 6, the first primary server and the second primary server disparately configured.

8. The system of claim 2, the job creator component updates the at least one table to indicate the partitions into which the task has been partitioned.

9. The system of claim 1, the database component distributes a subset of the at least one table to one or more servers included in a server farm.

10. The system of claim 1, the job creator component periodically sending a request for status information from at least one server in a server farm.

11. The system of claim 10, the job client component associated with the at least one server responds to the request for status information with server related status information.

12. The system of claim 11, the server related status information includes at least one of disk space usage, processor usage and number of jobs resident in a job queue.

13. A method for effectuating parallel aggregation, comprising:
supplying a subset of database records to each server in a server farm; and
receiving a source data file that includes a plurality of partitionable tasks.

14. The method of claim 13, further comprising dividing the source data file into the plurality of partitionable tasks.

15. The method of claim 14, each of the plurality of partitionable tasks employed to ascertain an appropriate server in the farm to which to assign the each of the plurality of partitionable tasks.

16. The method of claim 15, supplying one of the plurality of partitionable tasks to the appropriate server

17. The method of claim 16, periodically querying the appropriate server to ascertain information about the progress of one of the plurality of partitionable tasks.

18. The method of claim 15, the appropriate server grouped as a primary server.

19. The method of claim 15, the appropriate server grouped as a secondary server.

20. A system that effectuates parallel aggregation, comprising:
means for receiving and distributing a task that includes two or more disparately sized sub-tasks;
means for storing one or more data records; and
means for accepting a subset of the one or more data records and at one of the two or more disparately sized sub-tasks, the means for accepting and the means for receiving in periodic communication.
